(19) United States
(12) Patent Application Publication
(10) Pub. No.: US 2024/0365880 A1
(43) Pub. Date: Nov. 7, 2024

(54) AEROSOL GENERATING DEVICE AND OPERATION METHOD THEREOF

(71) Applicant: KT&G CORPORATION, Daejeon (KR)

(72) Inventors: Young Bum KWON, GYeonggi-do (KR); Hun II LIM, Seoul (KR); Dong Sung KIM, Seoul (KR); Yong Hwan KIM, Gyeonggi-do (KR); Seok Su JANG, Daejeon (KR)

(73) Assignee: KT&G CORPORATION, Daejeon (KR)

(21) Appl. No.: 18/563,793

(22) PCT Filed: Apr. 3, 2023
(86) PCT No.: PCT/KR2023/004465

§ 371 Date: Nov. 22, 2023

(30) Foreign Application Priority Data
Apr. 18, 2022 (KR) 10-2022-0047503
Aug. 11, 2022 (KR) 10-2022-0100681

(51) Int. Cl. A24F 40/57; A24F 40/465; A24F 40/51; H05B 6/10; H05B 6/36

(52) U.S. Cl. CPC A24F 40/57; A24F 40/465; A24F 40/51; H05B 6/10; H05B 6/36

(57) ABSTRACT

An aerosol generating device includes a heater configured to heat an aerosol generating article, a gas sensor configured to sense a concentration of a particular gas, and a controller configured to control a supply of power to the heater, wherein the controller is configured to determine any one temperature profile from among a plurality of temperature profiles on the basis of a sensing value of the gas sensor.

### TECHNICAL FIELD

The disclosure relates to an aerosol generating device and an operation method thereof.

### BACKGROUND ART

Recently, the demand for alternative methods for overcoming the shortcomings of general cigarettes has increased. For example, there is an increasing demand for a system for generating aerosols by heating a cigarette or an aerosol generating material by using an aerosol generating device, rather than by burning cigarettes. Accordingly, research on heating-type aerosol generating devices has been actively conducted.

### DISCLOSURE

### Technical Problem

Controlling heating of an aerosol generating article or a temperature of the aerosol generating device is the most significant key function of an aerosol generating device.

An existing aerosol generating device heats an aerosol generating article regardless of the actual heating degree of the aerosol generating article or the actual temperature of the aerosol generating article. Taking an induction heating-type aerosol generating device as an example, an existing aerosol generating device measures a temperature of a susceptor constituting a heater in a direct or indirect manner, and controls heating of an aerosol generating article by inferring a temperature of the aerosol generating article on the basis of the measured temperature of the susceptor.

An aerosol generating device disclosed herein provides a uniform smoking sensation to a user by measuring a concentration of a particular gas generated when an aerosol generating article is heated, and controlling heating of the aerosol generating article on the basis of the measured concentration of the particular gas.

Technical problems to be solved by embodiments are not limited to the problems described above, and problems not mentioned will be clearly understood by those skilled in the art to which the embodiments belong from the description and the accompanying drawings.

### Technical Solution

According to an aspect of the disclosure, an aerosol generating device includes a heater configured to heat an aerosol generating article, a gas sensor configured to sense a concentration of a particular gas, and a controller configured to control a supply of power to the heater, wherein the controller is configured to determine any one temperature profile from among a plurality of temperature profiles on the basis of a sensing value of the gas sensor.

### Advantageous Effects

An aerosol generating device disclosed herein may sense a concentration of a particular gas generated when an aerosol generating article is heated. Also, the aerosol generating device may identify the aerosol generating article on the basis of the sensed concentration of the particular gas. In addition, the aerosol generating device may determine any one temperature profile from among a plurality of temperature profiles on the basis of the sensed concentration of the particular gas. In addition, the aerosol generating device may provide a uniform smoking sensation to a user by fine-tuning the determined temperature profile on the basis of a value of the sensed concentration of the particular gas.

### DESCRIPTION OF DRAWINGS

FIG. 1 is a perspective view of an aerosol generating device according to an embodiment.

FIG. 2 is a cross-sectional view schematically illustrating components of an aerosol generating device, according to an embodiment.

FIG. 3 is an enlarged cross-sectional view of some components of an aerosol generating device, according to an embodiment.

FIG. 4 is a cross-sectional view illustrating a process of moving air according to a puff action of a user in the aerosol generating device illustrated in FIG. 3.

FIG. 5 is a flowchart illustrating a method of determining a temperature profile, according to an embodiment.

FIGS. 6 and 7 are graphs illustrating a temperature profile of an aerosol generating device, according to an embodiment.

FIG. 8 is a flowchart illustrating a method of tuning a temperature profile, according to an embodiment.

FIG. 9 is a block diagram of an aerosol generating device according to an embodiment.

### BEST MODE

An aerosol generating device of the disclosure has the following embodiments.

According to an aspect of the disclosure, an aerosol generating device includes a heater configured to heat an aerosol generating article, a gas sensor configured to sense a concentration of a particular gas, and a controller configured to control a supply of power to the heater, wherein the controller is configured to determine any one temperature profile from among a plurality of temperature profiles on the basis of a sensing value of the gas sensor.

According to another aspect of the disclosure, a method of controlling an operation of an aerosol generating device includes initiating a heating operation of a heater configured to heat an aerosol generating article, sensing a concentration of a particular gas of the aerosol generating device, and determining any one temperature profile from among a plurality of temperature profiles on the basis of a sensing value.

### MODE FOR INVENTION

Regarding the terms in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, terms which can be arbitrarily selected by the applicant in particular cases. In such a case, the meaning of the terms will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

As used herein, when an expression such as “at least any one” precedes arranged elements, it modifies all elements rather than each arranged element. For example, the expression “at least any one of a, b, and c” should be construed to include a, b, c, or a and b, a and c, b and c, or a, b, and c.

In an embodiment, an aerosol generating device may be a device that generates aerosols by electrically heating a cigarette accommodated in an interior space thereof.

The aerosol generating device may include a heater. In an embodiment, the heater may be an electro-resistive heater. For example, the heater may include an electrically conductive track, and the heater may be heated when currents flow through the electrically conductive track.

The heater may include a tube-shaped heating element, a plate-shaped heating element, a needle-shaped heating element, or a rod-shaped heating element, and may heat the inside or outside of a cigarette according to the shape of a heating element.

A cigarette may include a tobacco rod and a filter rod. The tobacco rod may be formed of sheets, strands, and tiny bits cut from a tobacco sheet. Also, the tobacco rod may be surrounded by a heat conductive material. For example, the heat conductive material may be, but is not limited to, a metal foil such as aluminum foil.

The filter rod may include a cellulose acetate filter. The filter rod may include at least one segment. For example, the filter rod may include a first segment configured to cool aerosols, and a second segment configured to filter a certain component in aerosols.

In another embodiment, the aerosol generating device may be a device that generates aerosols by using a cartridge containing an aerosol generating material.

The aerosol generating device may include a cartridge that contains an aerosol generating material, and a main body that supports the cartridge. The cartridge may be detachably coupled to the main body, but is not limited thereto. The cartridge may be integrally formed or assembled with the main body, and may also be fixed to the main body so as not to be detached from the main body by a user. The cartridge may be mounted on the main body while accommodating an aerosol generating material therein. However, the present disclosure is not limited thereto. An aerosol generating material may also be injected into the cartridge while the cartridge is coupled to the main body.

The cartridge may contain an aerosol generating material in any one of various states, such as a liquid state, a solid state, a gaseous state, a gel state, or the like. The aerosol generating material may include a liquid composition. For example, the liquid composition may be a liquid including a tobacco-containing material having a volatile tobacco flavor component, or a liquid including a non-tobacco material.

The cartridge may be operated by an electrical signal or a wireless signal transmitted from the main body to perform a function of generating aerosols by converting the phase of an aerosol generating material inside the cartridge into a gaseous phase. The aerosols may refer to a gas in which vaporized particles generated from an aerosol generating material are mixed with air.

In another embodiment, the aerosol generating device may generate aerosols by heating a liquid composition, and generated aerosols may be delivered to a user through a cigarette. In other words, the aerosols generated from the liquid composition may move along an airflow passage of the aerosol generating device, and the airflow passage may be configured to allow aerosols to be delivered to a user by passing through a cigarette.

In another embodiment, the aerosol generating device may be a device that generates aerosols from an aerosol generating material by using an ultrasonic vibration method. At this time, the ultrasonic vibration method may mean a method of generating aerosols by converting an aerosol generating material into aerosols with ultrasonic vibration generated by a vibrator.

The aerosol generating device may include a vibrator, and generate a short-period vibration through the vibrator to convert an aerosol generating material into aerosols. The vibration generated by the vibrator may be ultrasonic vibration, and the frequency band of the ultrasonic vibration may be in a frequency band of about 100 kHz to about 3.5 MHz, but is not limited thereto.

The aerosol generating device may further include a wick that absorbs an aerosol generating material. For example, the wick may be arranged to surround at least one area of the vibrator, or may be arranged to contact at least one area of the vibrator.

As a voltage (for example, an alternating voltage) is applied to the vibrator, heat and/or ultrasonic vibrations may be generated from the vibrator, and the heat and/or ultrasonic vibrations generated from the vibrator may be transmitted to the aerosol generating material absorbed in the wick. The aerosol generating material absorbed in the wick may be converted into a gaseous phase by heat and/or ultrasonic vibrations transmitted from the vibrator, and as a result, aerosols may be generated.

For example, the viscosity of the aerosol generating material absorbed in the wick may be lowered by the heat generated by the vibrator, and as the aerosol generating material having a lowered viscosity is granulated by the ultrasonic vibrations generated from the vibrator, aerosols may be generated, but is not limited thereto.

In another embodiment, the aerosol generating device is a device that generates aerosols by heating an aerosol generating article accommodated in the aerosol generating device in an induction heating method.

The aerosol generating device may include a susceptor and a coil. In an embodiment, the coil may apply a magnetic field to the susceptor. As power is supplied to the coil from the aerosol generating device, a magnetic field may be formed inside the coil. In an embodiment, the susceptor may be a magnetic body that generates heat by an external magnetic field. As the susceptor is positioned inside the coil and a magnetic field is applied to the susceptor, the susceptor generates heat to heat an aerosol generating article. In addition, optionally, the susceptor may be positioned within the aerosol generating article.

In another embodiment, the aerosol generating device may further include a cradle.

The aerosol generating device may configure a system together with a separate cradle. For example, the cradle may charge a battery of the aerosol generating device. Alternatively, the heater may be heated when the cradle and the aerosol generating device are coupled to each other.

Hereinafter, the present disclosure will now be described more fully with reference to the accompanying drawings, in which exemplary embodiments of the present disclosure are shown such that one of ordinary skill in the art may easily work the present disclosure. The present disclosure may be implemented in a form that can be implemented in the aerosol generating devices of the various embodiments described above or may be implemented in various different forms, and is not limited to the embodiments described herein.

Hereinafter, embodiments of the present disclosure will be described in detail with reference to the drawings.

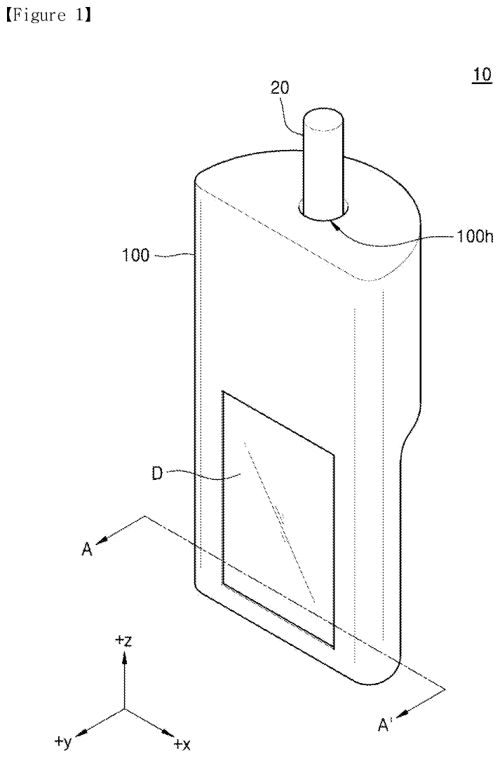

FIG. 1 is a perspective view of an aerosol generating device according to an embodiment.

Referring to FIG. 1, an aerosol generating device 10 according to an embodiment may include a housing 100 into which an aerosol generating article 20 may be inserted.

The housing 100 may form the overall appearance of the aerosol generating device 10, and may include an inner space (or an arrangement space) in which components of the aerosol generating device 10 may be arranged. FIG. 1 illustrates an embodiment in which the housing 100 has a cross section formed in a semicircular shape as a whole, but the shape of the housing 100 is not limited thereto. According to embodiments (not shown), the housing 100 may be formed in a cylindrical shape as a whole, or may be formed in a polygonal pillar shape (e.g., a triangular pillar shape or a rectangular pillar shape).

Components for generating aerosol by heating the aerosol generating article 20 inserted into the housing 100 and components for detecting a puff action of a user may be arranged in the inner space of the housing 100, and a detailed description thereof will be given below.

The housing 100 may include an opening 100h through which the aerosol generating article 20 may be inserted into the housing 100. At least a portion of the aerosol generating article 20 may be inserted or accommodated in the housing 100 through the opening 100h.

The aerosol generating article 20 inserted or accommodated in the housing 100 may be heated inside the housing 100, and as a result, aerosol may be generated. The aerosol generated inside the housing 100 may be discharged to the outside of the aerosol generating device 10 through the inserted aerosol generating article 20 and/or a space between the aerosol generating article 20 and the opening 100h, and the user may inhale the aerosol being discharged.

The aerosol generating device 10 may further include a display D on which visual information is displayed.

The display D may be arranged such that at least a partial region thereof is exposed on an outer side of the housing 100, and the aerosol generating device 10 may provide various types of visual information to the user through the display D.

For example, the aerosol generating device 10 may provide, via the display D, information regarding whether or not a puff action of the user occurs and/or information regarding the number of puffs remaining in the inserted aerosol generating article 20. In addition, the aerosol generating device 10 may provide, via the display D, information regarding the identified aerosol generating article 20. However, the provision of information via the display D is only an example, and information provided via the display D is not limited to the embodiment described above.

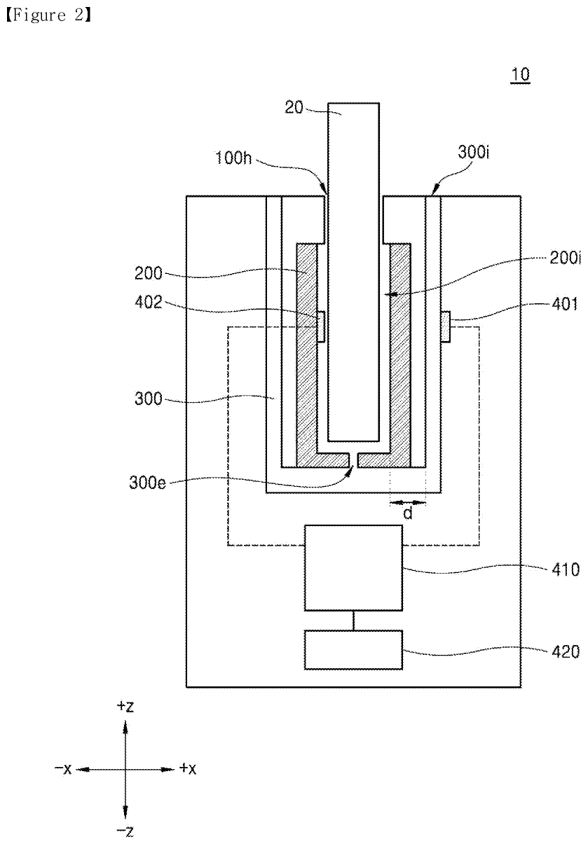

FIG. 2 is a cross-sectional view schematically illustrating components of an aerosol generating device, according to an embodiment. FIG. 2 is a cross-sectional view of the aerosol generating device 10 illustrated in FIG. 1, when viewed in an A-A′ direction.

Referring to FIG. 2, an aerosol generating device 10 (e.g., the aerosol generating device 10 of FIG. 1) according to an embodiment may include a housing 100 (e.g., the housing 100 of FIG. 1), a heater assembly 200, an air flow passage 300, a first sensor 401, and a second sensor 402.

The housing 100 may form the overall appearance of the aerosol generating device 10, and may include an inner space in which components of the aerosol generating device 10 may be arranged. For example, the heater assembly 200, the air flow passage 300, the first sensor 401, and the second sensor 402 may be arranged in an inner space of the housing 100, but are not limited thereto.

The housing 100 may include an opening 100h, and at least a portion of an aerosol generating article 20 may be inserted (or accommodated) in the housing 100 through the opening 100h. Although FIG. 2 illustrates an embodiment in which the opening 100h is formed in one region of the housing 100 facing a +z direction, an arrangement structure of the opening 100h is not limited to the illustrated embodiment.

The heater assembly 200 may be located in the inner space of the housing 100, and may heat the aerosol generating article 20 inserted into the housing 100 through the opening 100h to generate aerosol.

The heater assembly 200 may include an accommodation space 200i for accommodating at least a portion of the aerosol generating article 20 inserted into the housing 100 through the opening 100h, and a heater (not shown) for generating heat when power is supplied. At least one region of the aerosol generating article 20 accommodated in the accommodating space 200i may be heated by the heater, and vaporized particles generated by heating the aerosol generating article 20 may be mixed with air introduced into the inner space of the housing 100 through the opening 100h to generate aerosol.

The heater of the heater assembly 200 may include an induction heater. For example, the heater may include a coil (or an electrically conductive coil) for generating an alternating magnetic field when power is supplied, and a susceptor for generating heat by the alternating magnetic field generated by the coil. The susceptor may be arranged to surround at least a portion of an outer circumferential surface of the aerosol generating article 20 inserted into the housing 100, and may heat the inserted aerosol generating article 20.

The heater of the heater assembly 200 may include an electro-resistive heater. For example, the heater may include a film heater arranged to surround at least a portion of the outer circumferential surface of the aerosol generating article 20 inserted into the housing 100. The film heater may include an electrically conductive track, and when a current flows through the electrically conductive track, the film heater may generate heat and heat the aerosol generating article 20 inserted into the housing 100.

The heater of the heater assembly 200 may include at least one of a needle-type heater, a rod-type heater, and a tube-type heater capable of heating the inside of the aerosol generating article 20 inserted into the housing 100. The heater described above may, for example, be inserted into at least one region of the aerosol generating article 20 and heat the inside of the aerosol generating article 20.

The heater is not limited to the embodiments described above, and the embodiment of the heater may vary when the heater may heat the aerosol generating article 20 to a predefined temperature of the aerosol generating article 20. In the disclosure, the predefined temperature may refer to a temperature at which an aerosol generating material included in the aerosol generating article 20 may be heated to generate aerosol. The predefined temperature may be a preset temperature in the aerosol generating device 10, but the corresponding temperature may be changed by a type of aerosol generating device 10 and/or by an operation of a user.

The air flow passage 300 may be located between the housing 100 and the heater assembly 200 in the inner space of the housing 100, and may fluidly communicate (fluidly connect) the outside of the aerosol generating device 10 with the accommodation space 200i of the heater assembly 200.

While spaced apart from the heater assembly 200, the air flow passage 300 may be arranged to connect an air inlet 300i formed in one region of the housing 100 (e.g., one region in the +z direction) to an air outlet 300e formed in the accommodation space 200i of the heater assembly 200. For example, the air flow passage 300 may be formed in a substantially U shape while spaced apart from the heater assembly (200), and may be arranged to surround the heater assembly 200, but the shape of the air flow passage 300 is not limited to the aforementioned embodiment.

Due to the arrangement structure of the air flow passage 300 described above, the outside of the aerosol generating device 10 may be in fluid communication with the inside of the accommodation space 200i. As a result, air outside of the aerosol generating device 10 (hereinafter, referred to as external air) may be introduced into the air flow passage 300 through the air inlet 300i, and then may travel along the air flow passage 300 and move into the accommodation space 200i through the air outlet 300e.

The air flow passage 300 may be arranged to be spaced apart from the accommodation space 200i of the heater assembly 200 by a predefined distance d, and as a result, a temperature and/or pressure of the air flow passage 300 may not be affected by heat generated from the heater of the heater assembly 200.

The first sensor 401 may be arranged adjacent to the air flow passage 300 spaced apart from the accommodation space 200i of the heater assembly 200 by the predefined distance d. The first sensor 401 may detect a change in temperature or pressure of the air flow passage 300 according to a puff action of the user to detect a puff action of the user.

The first sensor 401 may include a pressure sensor for detecting a change in pressure, and may detect, via the pressure sensor, a change in pressure of the air flow passage 300 according to a puff action of the user. In another example, the first sensor 401 may include a temperature sensor for detecting a change in temperature, and may detect, via the temperature sensor, a change in temperature of the air flow passage 300 according to a puff action of the user.

The first sensor 401 may include both a pressure sensor and a temperature sensor, and may detect changes in both pressure and temperature of the air flow passage 300 according to a puff action of the user.

The second sensor 402 may be arranged within the accommodation space 200i of the heater assembly 200. The second sensor 402 may be spaced apart from the aerosol generating article 20 by a predefined distance and arranged within the accommodation space 200i of the heater assembly 200. The aerosol generating article 20 may be heated from the heater assembly 200 to generate aerosol, and the second sensor 402 may be arranged within the accommodation space 200i of the heater assembly 200 and sense a concentration of a particular gas of the aerosol. The arrangement of the second sensor 402 is not limited to the embodiments illustrated in FIGS. 1 to 4, and the second sensor 402 may be arranged at any location inside the aerosol generating device 10 at which the second sensor 402 may sense the concentration of the particular gas of the aerosol generated from the aerosol generating article 20.

The aerosol generating device 10 may further include a controller 410 and a battery 420.

The controller 410 may control the overall operation of the aerosol generating device 10. In an example, the controller 410 may be electrically or operatively connected to the heater of the heater assembly 200 to control an operation of the heater.

The controller 410 may be electrically or operatively connected to the first sensor 401 to detect a puff action of the user on the basis of a change in pressure or temperature of the air flow passage 300 detected by the first sensor 401.

In the disclosure, the expression “operatively connected” may indicate that components are connected to each other to transmit and/or receive signals, optical signals and/or magnetic signals to and/or from each other via wireless communication, and the corresponding expression may be used in the same sense below.

The controller 410 may be electrically or operatively connected to the second sensor 402 to control the operation of the heater assembly 200 on the basis of a concentration of the particular gas sensed by the second sensor 402.

The controller 410 may be disposed or mounted on a printed circuit board (not shown) located in the inner space of the housing 100, and may be electrically or operatively connected to the heater and/or the first sensor 401 via an electrical connection unit (e.g., a cable, a C-clip, a flexible printed circuit board (FPCB), or the like) for connecting the printed circuit board, the heater of the heater assembly 200, and/or the first sensor 401 to one another. However, the arrangement structure of the controller 410 is not limited to the embodiment described above, and the arrangement structure of the controller 410 may be changed according to embodiments.

The battery 420 may supply power needed for the operation of the aerosol generating device 10. For example, the battery 420 may supply power to the heater to heat the heater of the heater assembly 200. As another example, the battery 420 may supply power needed for the operation of the controller 410, or may supply power needed for the operations of the first sensor 401 and the second sensor 402.

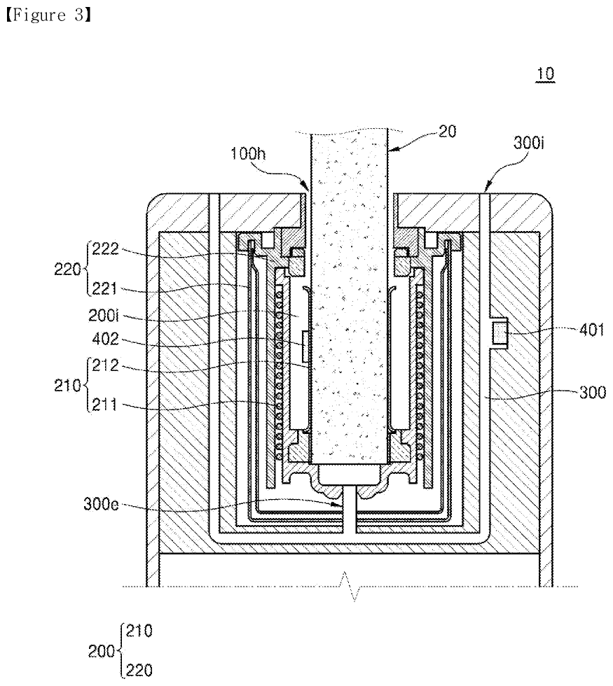

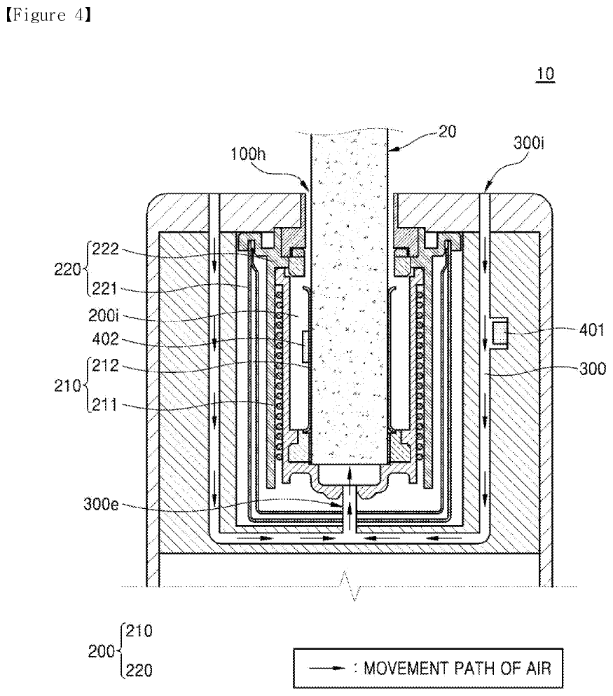

Hereinafter, a detailed structure of the heater assembly 200 of the aerosol generating device 10 and the movement of air according to a user's puff action will be described in detail with reference to FIGS. 3 and 4.

FIG. 3 is an enlarged cross-sectional view of some components of an aerosol generating device, according to an embodiment. FIG. 3 is a cross-sectional view illustrating the heater assembly 200 of the aerosol generating device 10 of FIG. 2 in detail.

Referring to FIG. 1 and FIG. 3, an aerosol generating device 10 according to an embodiment may include a housing 100, a heater assembly 200, an air flow passage 300, a first sensor 401, and a second sensor 402. At least one of components of the aerosol generating device 10 according to an embodiment may be the same as or similar to at least one of the components of the aerosol generating device 10 illustrated in FIG. 2, and the same description thereof will be omitted below.

The heater assembly 200 may be located in an inner space of the housing 100, and may include an accommodation space 200i for accommodating an aerosol generating article 20 inserted into the inner space of the housing 100 through an opening 100h, and a heater 210 for heating the aerosol generating article 20 accommodated in the accommodation space 200i.

According to an embodiment, the heater 210 may include a coil 211 and a susceptor 212, and may heat at least one region of the aerosol generating article 20 accommodated in the accommodation space 200i by using an induction heating method.

The coil 211 may be arranged to surround an outer circumferential surface of the susceptor 212, and may be supplied with power from a battery (e.g., the battery 420 of FIG. 2) to generate an alternating magnetic field.

The susceptor 212 may be arranged to surround at least a portion of an outer circumferential surface of the aerosol generating article 20 accommodated in the accommodation space 200i, and may heat the aerosol generating article 20 accommodated in the accommodation space 200i. For example, the susceptor 212 may heat the aerosol generating article 20 accommodated in the accommodation space 200i by generating heat by the alternating magnetic field generated by the coil 211.

However, the embodiment of the heater 210 is not limited to the embodiment described above, and according to embodiments, the heater 210 may include an electro-resistive heater capable of heating the inside and/or outside of the aerosol generating article 20 accommodated in the accommodation space 200i.

The heater assembly 200 may further include a heat insulation structure 220 for sealing the heater 210.

The heat insulation structure 220 may be arranged to surround the heater 210 and may seal the heater 210, to prevent droplets generated during an aerosol generation process through the heater 210 from leaking to the outside of the heater assembly 200, and thus may prevent the components of the aerosol generating device 10 from malfunctioning or being damaged by the droplets.

In addition, the heat insulation structure 220 may seal the heater 210 to prevent heat generated from the heater 210 from being transferred to an outer circumferential surface of the housing 100, and thus may prevent high-temperature heat from being transferred to the body of a user (e.g., a palm) holding the housing 100 even when a temperature of the heater 210 is maintained at a high temperature.

The heat insulation structure 220 may include a first structure 221 arranged to surround one region (e.g., a lower region and a side region) of an outer circumferential surface of the heater 210, and a second structure 222 located at a top end of the first structure 221 and covering the other region (e.g., a top region) of the outer circumferential surface of the heater 210. The heater 210 may be located in an inner space formed by the first structure 221 and the second structure 222, and the first structure 221 and the second structure 222 may seal the heater 210 located in the inner space.

The second structure 222 may be coupled to at least one region of a top end of the first structure 221, but is not limited thereto. In an embodiment (not shown), the first structure 221 and the second structure 222 may be integrally formed.

While spaced apart from the heater assembly 200, the air flow passage 300 may be arranged to fluidly communicate the outside of the aerosol generating device 10 with the accommodation space 200i of the heater assembly 200, and thus may operate as a flow path through which external air flows into the accommodation space 200i.

The air flow passage 300 may be arranged to connect an air inlet 300i formed in one region of the housing 100 to an air outlet 300e formed in the accommodation space 200i of the heater assembly 200. Here, the air outlet 300e may be formed to pass through at least one region of the heater assembly 200, so that the inside of the accommodation space 200i may be connected to the air flow passage 300.

External air may be introduced into the accommodation space 200i through the air flow passage 300. The external air introduced into the accommodation space 200i may be mixed with vaporized particles generated when the aerosol generating article 20 is heated by the heater 210, and as a result, aerosol may be generated.

The first sensor 401 may be arranged adjacent to the air flow passage 300 to detect a change in temperature or pressure of the air flow passage 300. For example, the first sensor 401 may be located within a passage branched away from the heater assembly 200 at one point in the air flow passage 300, and may detect a change in temperature or pressure of the air flow passage 300 due to a puff action of the user, but the arrangement structure of the first sensor 401 is not limited to the embodiment described above.

The first sensor 401 may include a pressure sensor to detect an amount of a change in pressure of the air flow passage 300 according to a puff action of the user, but is not limited thereto. In an example, the first sensor 401 may also include a temperature sensor to detect an amount of a change in temperature of the air flow passage 300 according to a puff action of the user.

Information regarding the amount of a change in temperature or pressure of the air flow passage 300 detected by the first sensor 401 may be transmitted to a processor (e.g., the controller 410 of FIG. 2), and the processor may detect whether a puff action of the user occurs, on the basis of the amount of a change in temperature or pressure of the air flow passage 300 detected by the first sensor 401.

The air flow passage 300 may be spaced apart from the accommodation space 200i of the heater assembly 200 by a predefined distance (e.g., the predefined distance d in FIG. 2), so that a temperature and/or pressure inside the air flow passage 300 are not changed by heat generated from the heater 210.

The second sensor 402 may include a gas sensor that is sensitive to a particular gas, and may sense a particular gas component of aerosol that is present in the accommodation space 200i of the heater assembly 200.

The gas sensor according to an embodiment may be a semiconductor gas sensor. The gas sensor is an N-type semiconductor gas sensor, in particular, a tin oxide gas sensor. The N-type semiconductor sensor reduces an electrical resistance thereof in the presence of a reducing gas, such as carbon monoxide (CO) or ammonia. Also, the N-type semiconductor sensor increases the electrical resistance thereof in the presence of an oxidizing gas, such as oxygen, nitrogen monoxide (NO), or nitrogen dioxide (NO2). A P-type semiconductor gas sensor may also be used. The P-type semiconductor gas sensor operates in a manner opposite to the N-type semiconductor sensor, and thus increases an electrical resistance thereof in the presence of a reducing gas and reduces the electrical resistance thereof in the presence of an oxidizing gas. The second sensor 402 may sense a concentration of a particular gas by analyzing the degree of reduction in an electrical resistance.

A gas sensor according to an embodiment may be an optical gas sensor. The optical gas sensor may include a light emitting device that emits light, a light receiving device that receives light, and an optical waveguide located between the light emitting device and the light receiving device to provide a path through which light travels. The light emitting device may emit infrared rays. The light receiving device may receive infrared rays. Light emitted from the light emitting device may travel through the optical waveguide and reach the light receiving device. A gaseous material has a property of strongly absorbing light having a particular wavelength for each material. A gas present in the optical waveguide strongly absorbs light having a particular wavelength for each material, and thus, a light absorption spectrum sensed by the light receiving device varies according to a type of gas present in the optical waveguide. The gas sensor may sense a concentration of a particular gas by analyzing the light absorption spectrum sensed by the light receiving device. In an embodiment, the heater assembly 200 may form one surface of the optical waveguide. In detail, the susceptor 212 constituting the heater assembly 200 may be formed of metal, and may form one surface of the optical waveguide to provide a path through which light emitted from the light emitting device travels.

FIG. 4 is a cross-sectional view illustrating a process of moving air according to a puff action of a user in the aerosol generating device 10 illustrated in FIG. 3. An aerosol generating device 10 illustrated in FIG. 4 may be substantially the same as or similar to the aerosol generating device 10 of FIG. 3, and the same description thereof will be omitted below.

Referring to FIG. 1 and FIG. 4, the aerosol generating device 10 according to an embodiment may detect a change in pressure or temperature of an air flow passage 300 via a first sensor 401, and may detect a puff action of a user on the basis of the detected change in pressure or temperature of the air flow passage 300.

When the user contacts an aerosol generating article 20 withe the mouth and performs a puff action, a pressure difference occurs between the outside of the aerosol generating device 10 and an inner space of a housing 100, and thus, external air may flow into the housing 100 through an air inlet 300i. The external air introduced into the housing 100 may travel along the air flow passage 300 and reach an air outlet 300e, and the external air reaching the air outlet 300e may pass through the air outlet 300e and flow into an accommodation space 200i of a heater assembly 200.

Here, the external air introduced into the accommodation space 200i may be mixed with vaporized particles generated when the aerosol generating article 20 is heated, and thus may generate aerosol, and the user may inhale, via a puff action, the aerosol generated in the accommodation space 200i. A second sensor 402 may sense a particular gas of the aerosol present in the accommodation space 200i.

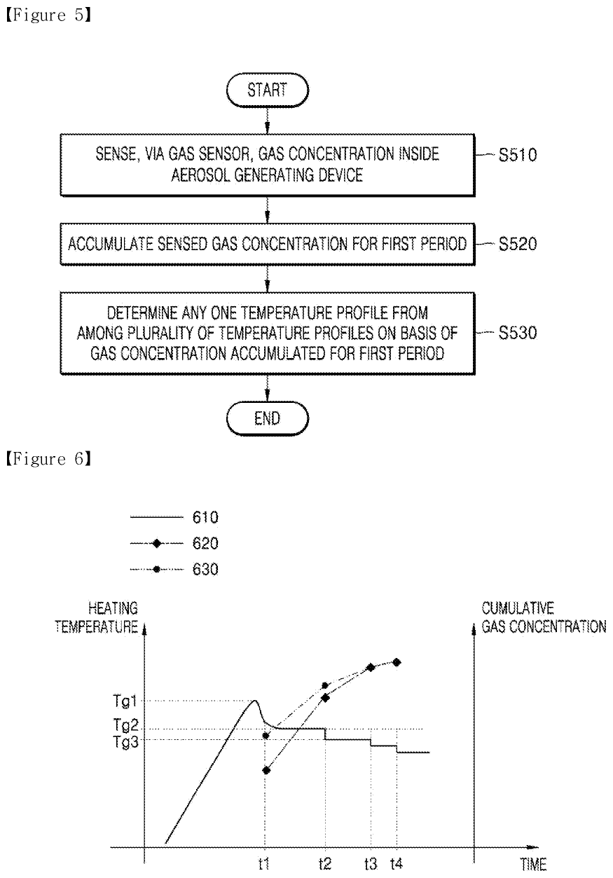

FIG. 5 is a flowchart illustrating a method of determining a temperature profile, according to an embodiment.

Referring to FIGS. 1 to 5, the controller 410 may determine a temperature profile for the heater 210. The temperature profile for the heater 210 refers to a series of pieces of information recorded with respect to a method of controlling a temperature of the heater 210 over time. The controller 410 reads at least one temperature profile from among a plurality of temperature profiles stored in a memory (not shown), and then controls power supplied to the heater 210 according to the read temperature profile. When the power supplied to the heater 210 is appropriately controlled, the flavor of aerosol generated may vary according to a temperature profile applied to heating of the heater 210. For example, a user may feel a soft smoking sensation or deep smoking sensation according to a temperature profile while smoking with an aerosol generating device.

The user may insert various types of aerosol generating articles 20 into the aerosol generating device. An aerosol generating device according to an embodiment may identify the aerosol generating article 20 inserted into the aerosol generating device, and may control an operation of the heater 210 by determining an optimal temperature profile according to a result of the identification.

Different aerosol generating articles 20 may include different aerosol generating materials. In addition, different aerosol generating articles 20 may have different composition ratios of aerosol generating materials. The aerosol generating articles 20 may include different flavor components for respective types.

The controller 410 may identify the aerosol generating article 20 inserted into the aerosol generating device by using a lookup table stored in the memory. The lookup table includes data indicating one or more concentrations, and each concentration value is related to data for identifying the aerosol generating article 20. Also, the lookup table may include data indicating one or more concentrations, and each concentration value may be related to a temperature profile. In detail, the lookup table stored in the memory may include information regarding a cumulative gas concentration expected value to be described below. A temperature profile may include a plurality of periods. For example, the temperature profile may include a preheating period and a smoking period.

In operation S510, the second sensor 402 of the aerosol generating device senses a gas concentration inside the aerosol generating device. In detail, the second sensor 402 may sense a particular gas component of aerosol present in the accommodation space 200i of the heater assembly 200.

In operation S520, the controller 410 of the aerosol generating device may accumulate the sensed gas concentration for a first period on the basis of a sensing value received from the second sensor 402. The first period may be a period before the preheating period ends. In other words, in operation S520, in a certain period before the preheating period ends, the controller 410 may calculate a cumulative value for a particular gas component of aerosol generated by the aerosol generating article 20 inserted into the aerosol generating device.

In operation S530, the controller 410 of the aerosol generating device may identify the aerosol generating article 20 inserted into the aerosol generating device by comparing the accumulated gas concentration with the lookup table stored in the memory. In addition, the controller 410 may determine any one temperature profile from among a plurality of temperature profiles stored in the memory by comparing the accumulated gas concentration with the lookup table stored in the memory. Accordingly, the controller 410 may control an operation of the heater by determining an optimal temperature profile appropriate for the identified aerosol generating article 20.

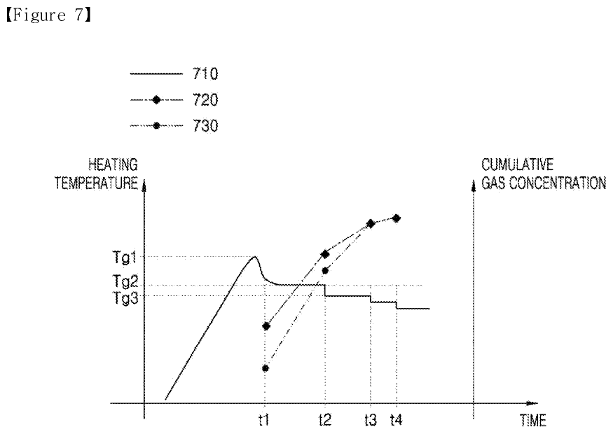

FIGS. 6 and 7 are graphs illustrating a temperature profile of an aerosol generating device, according to an embodiment.

In FIGS. 6 and 7, a horizontal axis indicates a time axis, a left vertical axis indicates a temperature, and a right vertical axis indicates a cumulative gas concentration.

Graphs 610 and 710 are graphs indicating a heating temperature of a heater, graphs 620 and 720 indicate a cumulative gas concentration expected value, and graphs 630 and 730 indicate a cumulative gas concentration sensing value.

A temperature profile may include a plurality of periods. For example, the temperature profile may be divided into a preheating period and a smoking period, a period before t1 indicates a preheating period, and a period after t1 indicates a smoking period.

In the preheating period, a temperature of a heater may increase from room temperature to a target temperature Tg1 which is a temperature at which an aerosol generating material is easily vaporized. In the preheating period, the temperature of the heater may be lowered by a certain range after reaching the target temperature Tg1.

In the smoking period, a sufficient amount of aerosol generating material to provide a rich smoking sensation to a user may be vaporized from the aerosol generating article 20. In the smoking period, the temperature of the heater may decrease stepwise. For example, the smoking period may include a holding period in which the temperature of the heater is maintained for a certain time and a lowering period in which the temperature of the heater is lowered by a certain range. In the smoking period, the temperature of the heater may be gradually or stepwise lowered according to a combination of the holding period and the lowering period.

As described above, in the aerosol generating device according to an embodiment, the controller 410 controls an operation of the heater by identifying the aerosol generating article 20 inserted into the aerosol generating device and determining an optimal temperature profile.

The temperature profile may be designed on the basis of a concentration of a particular gas of aerosol. The flavor of the aerosol or the smoking sensation of the aerosol may be determined according to the concentration of the particular gas of the aerosol. The concentration of the particular gas of the aerosol may be determined according to a heating state of the aerosol generating article 20. The concentration of the particular gas at which an optimal flavor or smoking sensation may be delivered to the user may be derived through an experiment, and an optimal temperature profile, which reflects the heating state of the aerosol generating article enabling the concentration of the particular gas to occur, may be designed.

However, even when the temperature of the heater is precisely controlled according to the temperature profile, the heating state of the aerosol generating article 20 may vary according to the humidity of the aerosol generating article 20, and humidity and temperature conditions outside the aerosol generating device, and thus, a concentration of a particular gas of aerosol actually generated may be different from a concentration of a particular gas in an experiment condition.

In FIGS. 6 and 7, the graphs 620 and 720 indicate a cumulative gas concentration value (hereinafter, a cumulative gas concentration expected value) occurring in experimental conditions at the time of designing the temperature profile. In other words, the temperature profile showing the graphs 610 and 710 may be a temperature profile designed on the basis of the cumulative gas concentration expected value of the graphs 620 and 720, and may provide an optimal smoking sensation to a user when a heating state of the aerosol generating article 20 matches the graph 620. Each of a plurality of temperature profiles stored in a memory includes information regarding a cumulative gas concentration expected value. The graphs 630 and 730 indicate a cumulative gas concentration value (hereinafter, a cumulative gas concentration sensing value) calculated by accumulating values sensed by the second sensor 402 in an actual smoking environment.

FIG. 6 illustrates that the cumulative gas concentration sensing value is higher than the cumulative gas concentration expected value at a time point t1. A difference as described above may occur when humidity of the aerosol generating article 20 is low or an external temperature of the aerosol generating device is high, compared to experimental conditions at the time of designing a temperature profile.

The heating state of the aerosol generating article 20 needs to match the graph 620 to provide an optimal smoking sensation to the user, and thus, the temperature profile needs to be fine-tuned.

The controller 410 may fine-tune the temperature profile determined on the basis of a difference value between the cumulative gas concentration sensing value of the graph 630 and the cumulative gas concentration expected value of the graph 620. In detail, as illustrated in FIG. 6, when the cumulative gas concentration sensing value is higher than the cumulative gas concentration expected value, i.e., when a difference value between the cumulative gas concentration sensing value of the graph 630 and the cumulative gas concentration expected value of the graph 620 is a positive number, the controller 410 needs to further reduce the degree of heating of the aerosol generating article 20.

As an embodiment of a method of further reducing the degree of heating of the aerosol generating article 20, the controller 410 may adjust a target temperature in a second period (t1 to t2) after a first period to be lower than a preset target temperature Tg2. Alternatively, the controller 410 may adjust the second period after the first period to be shorter than a preset period by adjusting a time point t2 to be advanced. Alternatively, the target temperature in the second period after the first period may be lowered more than the preset target temperature Tg2, and the second period may be adjusted to be shorter than the preset period.

Via fine-tuning of the temperature profile as described above, a difference between the cumulative gas concentration sensing value of the graph 630 and the cumulative gas concentration expected value of the graph 620 may be gradually reduced, and the user may be provided with an optimal smoking sensation.

In an embodiment different from the embodiment of FIG. 6, FIG. 7 illustrates that a cumulative gas concentration sensing value is lower than a cumulative gas concentration expected value at a time point t1. The difference described above may occur when humidity of the aerosol generating article 20 is high or an external temperature of the aerosol generating device is low, compared to experimental conditions at the time of designing a temperature profile.

Like the illustration in FIG. 6, the graph 710 indicating a heating state of the aerosol generating article 20 needs to match the graph 720 to provide an optimal smoking sensation to a user, and thus, a temperature profile needs to be fine-tuned.

The controller 410 may fine-tune a temperature profile determined on the basis of a difference value between a cumulative gas concentration sensing value of the graph 730 and a cumulative gas concentration expected value of the graph 720. In detail, as illustrated in FIG. 7, when the cumulative gas concentration sensing value is lower than the cumulative gas concentration expected value, i.e., when a difference value between the cumulative gas concentration sensing value of the graph 730 and the cumulative gas concentration expected value of the graph 720 is a negative number, the controller 410 needs to further increase the degree of heating of the aerosol generating article 20.

As an embodiment of a method of further increasing the degree of heating of the aerosol generating article 20, the controller 410 may adjust a target temperature in a second period (t1 to t2) after a first period to be higher than a preset target temperature Tg2. Alternatively, the controller 410 may adjust the second period after the first period to be longer than a preset period by adjusting a time point t2 to be delayed. Alternatively, the target temperature in the second period after the first period may be adjusted to be higher than the preset target temperature Tg2, and the second period may be adjusted to be longer than the preset period.

Via fine-tuning of the temperature profile as described above, a difference between the cumulative gas concentration sensing value of the graph 730 and the cumulative gas concentration expected value of the graph 720 may be gradually reduced, and the user may be provided with an optimal smoking sensation.

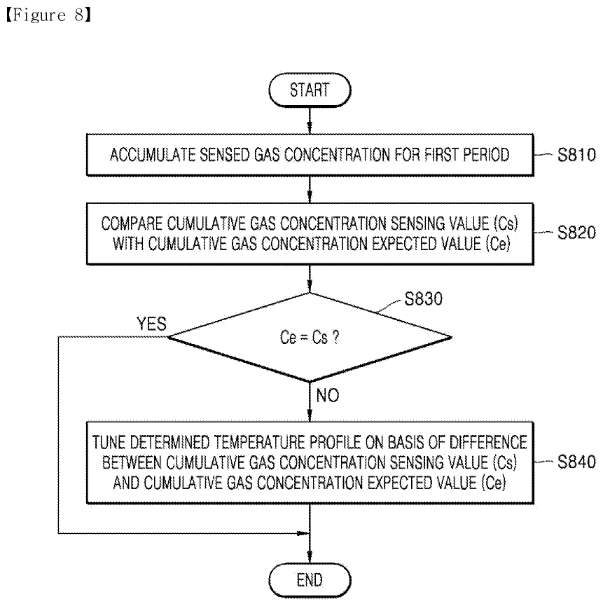

FIG. 8 is a flowchart illustrating a method of tuning a temperature profile, according to an embodiment.

In operation S810, the controller 410 of the aerosol generating device may accumulate a sensed gas concentration for a first period on the basis of a sensing value received from the second sensor 402. The first period may be a period immediately before a preheating period ends. In other words, in operation S520, in a certain period before the preheating period ends, a cumulative value for a particular gas component of aerosol generated by the aerosol generating article 20 inserted into the aerosol generating device may be calculated.

In operations S820 and S830, the controller 410 of the aerosol generating device compares the cumulative gas concentration (the cumulative gas concentration sensing values in FIGS. 6 and 7) with a cumulative gas concentration expected value stored in a memory. As a result of the comparison, when the cumulative gas concentration sensing value and the cumulative gas concentration expected value are not the same as each other, i.e., when a difference occurs therebetween, in operation S840, the controller 410 fine-tunes a temperature profile on the basis of a difference value between the cumulative gas concentration sensing value and the cumulative gas concentration expected value.

A method of fine-tuning the temperature profile is the same as those described with reference to FIGS. 6 and 7, and thus will be omitted.

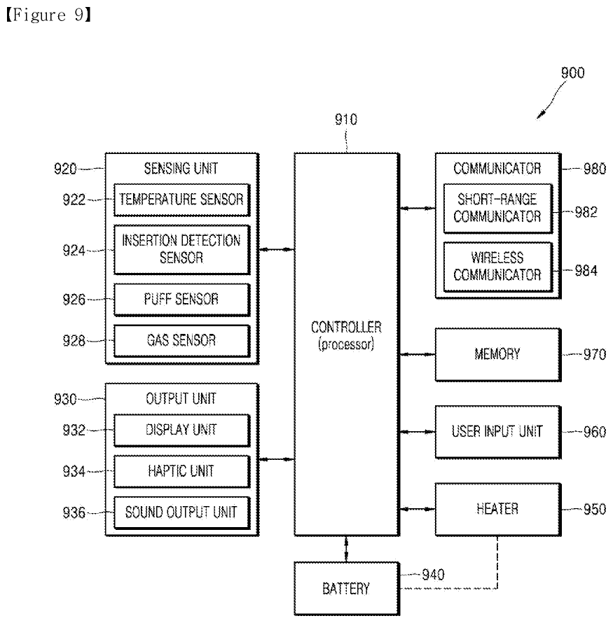

FIG. 9 is a block diagram of an aerosol generating device 900 according to another embodiment.

The aerosol generating device 900 may include a controller 910, a sensing unit 920, an output unit 930, a battery 940, a heater 950, a user input unit 960, a memory 970, and a communication unit 980. However, the internal structure of the aerosol generating device 900 is not limited to those illustrated in FIG. 9. In other words, according to the design of the aerosol generating device 900, it will be understood by one of ordinary skill in the art that some of the components shown in FIG. 9 may be omitted or new components may be added.

The sensing unit 920 may sense a state of the aerosol generating device 900 and a state around the aerosol generating device 900, and transmit sensed information to the controller 910. Based on the sensed information, the controller 910 may control the aerosol generating device 900 to perform various functions, such as controlling an operation of the heater 950, limiting smoking, determining whether an aerosol generating article (e.g., a cigarette, a cartridge, or the like) is inserted, displaying a notification, or the like.

The sensing unit 920 may include at least one of a temperature sensor 922, an insertion detection sensor, a puff sensor 926, and a gas sensor 928, but is not limited thereto.

The temperature sensor 922 may sense a temperature at which the heater 950 (or an aerosol generating material) is heated. The aerosol generating device 900 may include a separate temperature sensor for sensing the temperature of the heater 950, or the heater 950 may serve as a temperature sensor. Alternatively, the temperature sensor 922 may also be arranged around the battery 940 to monitor the temperature of the battery 940.

The insertion detection sensor 924 may sense insertion and/or removal of an aerosol generating article. For example, the insertion detection sensor 924 may include at least one of a film sensor, a pressure sensor, an optical sensor, a resistive sensor, a capacitive sensor, an inductive sensor, and an infrared sensor, and may sense a signal change according to the insertion and/or removal of an aerosol generating article.

The puff sensor 926 may sense a user's puff on the basis of various physical changes in an airflow passage or an airflow channel. For example, the puff sensor 926 may sense a user's puff on the basis of any one of a temperature change, a flow change, a voltage change, and a pressure change.

The gas sensor 928 may sense a concentration of a particular gas of aerosol present in the aerosol generating device 900. The gas sensor 928 may be a semiconductor gas sensor or an optical gas sensor.

The sensing unit 920 may include, in addition to the temperature sensor 922, the insertion detection sensor 924, the puff sensor 926, and the gas sensor 928 described above, at least one of a temperature/humidity sensor, a barometric pressure sensor, a magnetic sensor, an acceleration sensor, a gyroscope sensor, a location sensor (e.g., a global positioning system (GPS)), a proximity sensor, and a red-green-blue (RGB) sensor (illuminance sensor). Because a function of each of sensors may be intuitively inferred by one of ordinary skill in the art from the name of the sensor, a detailed description thereof may be omitted.

The output unit 930 may output information on a state of the aerosol generating device 900 and provide the information to a user. The output unit 930 may include at least one of a display unit 932, a haptic unit 934, and a sound output unit 936, but is not limited thereto. When the display unit 932 and a touch pad form a layered structure to form a touch screen, the display unit 932 may also be used as an input device in addition to an output device.

The display unit 932 may visually provide information about the aerosol generating device 900 to the user. For example, information about the aerosol generating device 900 may mean various pieces of information, such as a charging/discharging state of the battery 940 of the aerosol generating device 900, a preheating state of the heater 950, an insertion/removal state of an aerosol generating article, or a state in which the use of the aerosol generating device 900 is restricted (e.g., sensing of an abnormal object), or the like, and the display unit 932 may output the information to the outside. The display unit 932 may be, for example, a liquid crystal display panel (LCD), an organic light-emitting diode (OLED) display panel, or the like. In addition, the display unit 932 may be in the form of a light-emitting diode (LED) light-emitting device.

The haptic unit 934 may tactilely provide information about the aerosol generating device 900 to the user by converting an electrical signal into a mechanical stimulus or an electrical stimulus. For example, the haptic unit 934 may include a motor, a piezoelectric element, or an electrical stimulation device.

The sound output unit 936 may audibly provide information about the aerosol generating device 900 to the user. For example, the sound output unit 936 may convert an electrical signal into a sound signal and output the same to the outside.

The battery 940 may supply power used to operate the aerosol generating device 900. The battery 940 may supply power such that the heater 950 may be heated. In addition, the battery 940 may supply power required for operations of other components (e.g., the sensing unit 920, the output unit 930, the user input unit 960, the memory 970, and the communication unit 980) in the aerosol generating device 900. The battery 940 may be a rechargeable battery or a disposable battery. For example, the battery 940 may be a lithium polymer (LiPoly) battery, but is not limited thereto.

The heater 950 may receive power from the battery 940 to heat an aerosol generating material. Although not illustrated in FIG. 9, the aerosol generating device 900 may further include a power conversion circuit (e.g., a direct current (DC)/DC converter) that converts power of the battery 940 and supplies the same to the heater 950. In addition, when the aerosol generating device 900 generates aerosols in an induction heating method, the aerosol generating device 900 may further include a DC/alternating current (AC) that converts DC power of the battery 940 into AC power.

The controller 910, the sensing unit 920, the output unit 930, the user input unit 960, the memory 970, and the communication unit 980 may each receive power from the battery 940 to perform a function. Although not illustrated in FIG. 9, the aerosol generating device 900 may further include a power conversion circuit that converts power of the battery 940 to supply the power to respective components, for example, a low dropout (LDO) circuit, or a voltage regulator circuit.

In an embodiment, the heater 950 may be formed of any suitable electrically resistive material. For example, the suitable electrically resistive material may be a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like, but is not limited thereto. In addition, the heater 950 may be implemented by a metal wire, a metal plate on which an electrically conductive track is arranged, a ceramic heating element, or the like, but is not limited thereto.

In another embodiment, the heater 950 may be a heater of an induction heating type. For example, the heater 950 may include a susceptor that heats an aerosol generating material by generating heat through a magnetic field applied by a coil.

The user input unit 960 may receive information input from the user or may output information to the user. For example, the user input unit 960 may include a key pad, a dome switch, a touch pad (a contact capacitive method, a pressure resistance film method, an infrared sensing method, a surface ultrasonic conduction method, an integral tension measurement method, a piezo effect method, or the like), a jog wheel, a jog switch, or the like, but is not limited thereto. In addition, although not illustrated in FIG. 9, the aerosol generating device 900 may further include a connection interface, such as a universal serial bus (USB) interface, and may connect to other external devices through the connection interface, such as the USB interface, to transmit and receive information, or to charge the battery 940.

The memory 970 is a hardware component that stores various types of data processed in the aerosol generating device 900, and may store data processed and data to be processed by the controller 910. The memory 970 may include at least one type of storage medium from among a flash memory type, a hard disk type, a multimedia card micro type memory, a card-type memory (for example, secure digital (SD) or extreme digital (XD) memory, etc.), random access memory (RAM), static random access memory (SRAM), read-only memory (ROM), electrically erasable programmable read-only memory (EEPROM), programmable read-only memory (PROM), a magnetic memory, a magnetic disk, and an optical disk. The memory 970 may store an operation time of the aerosol generating device 900, the maximum number of puffs, the current number of puffs, at least one temperature profile, data on a user's smoking pattern, and the like.

In an embodiment, the memory 970 may store a lookup table. The lookup table includes data indicating one or more concentrations, and each concentration value is related to data for identifying an aerosol generating article. In addition, the lookup table may include data indicating one or more concentrations, and each concentration value may be related to a temperature profile. The lookup table may include information regarding a cumulative gas concentration expected value.

The communication unit 980 may include at least one component for communication with another electronic device. For example, the communication unit 980 may include a short-range wireless communication unit 982 and a wireless communication unit 984.

The short-range wireless communication unit 982 may include a Bluetooth communication unit, a Bluetooth Low Energy (BLE) communication unit, a near field communication unit, a wireless LAN (WLAN) (Wi-Fi) communication unit, a Zigbee communication unit, an infrared data association (IrDA) communication unit, a Wi-Fi Direct (WFD) communication unit, an ultra-wideband (UWB) communication unit, an Ant+ communication unit, or the like, but is not limited thereto.

The wireless communication unit 984 may include a cellular network communication unit, an Internet communication unit, a computer network (e.g., local area network (LAN) or wide area network (WAN)) communication unit, or the like, but is not limited thereto. The wireless communication unit 984 may also identify and authenticate the aerosol generating device 900 within a communication network by using subscriber information (e.g., International Mobile Subscriber Identifier (IMSI)).

The controller 910 may control general operations of the aerosol generating device 900. In an embodiment, the controller 910 may include at least one processor. The processor may be implemented as an array of a plurality of logic gates or may be implemented as a combination of a general-purpose microprocessor and a memory in which a program executable by the microprocessor is stored. It will be understood by one of ordinary skill in the art that the processor may be implemented in other forms of hardware.

The controller 910 may control the temperature of the heater 950 by controlling supply of power of the battery 940 to the heater 950. For example, the controller 910 may control power supply by controlling switching of a switching element between the battery 940 and the heater 950. In another example, a direct heating circuit may also control power supply to the heater 950 according to a control command of the controller 910.

The controller 910 may analyze a result sensed by the sensing unit 920 and control subsequent processes to be performed. For example, the controller 910 may control power supplied to the heater 950 to start or end an operation of the heater 950 on the basis of a result sensed by the sensing unit 920. As another example, the controller 910 may control, based on a result sensed by the sensing unit 920, an amount of power supplied to the heater 950 and the time the power is supplied, such that the heater 950 may be heated to a certain temperature or maintained at an appropriate temperature.

The controller 910 may control the output unit 930 on the basis of a result sensed by the sensing unit 920. For example, when the number of puffs counted through the puff sensor 926 reaches a preset number, the controller 910 may notify the user that the aerosol generating device 900 will soon be terminated through at least one of the display unit 932, the haptic unit 934, and the sound output unit 936.

In an embodiment, the controller 910 may control a power supply time and/or power supply with respect to the heater 950 according to a state of an aerosol generating article (e.g., the aerosol generating article 20 of FIG. 1) sensed by the sensing unit 920. For example, when the aerosol generating article 20 is over-moisturized, the controller 910 may increase a preheating time more than when the aerosol generating article 20 is in a normal state by controlling a power supply time with respect to an induction coil (e.g., the induction coil 211 of FIG. 3).

In an embodiment, the controller 910 may accumulate a sensed gas concentration for a first period on the basis of a sensing value received from the gas sensor 928. The controller 910 may identify the aerosol generating article inserted into the aerosol generating device 900 by comparing the cumulative gas concentration with a lookup table stored in a memory. In addition, the controller 910 may determine any one temperature profile from among a plurality of temperature profiles stored in the memory by comparing the cumulative gas concentration with the lookup table stored in the memory.

In an embodiment, the controller 910 may tune the determined temperature profile on the basis of the sensing value of the gas sensor 928. In detail, the controller 910 may tune the determined temperature profile in proportion to a difference value between the cumulative gas concentration value and a preset cumulative gas concentration expected value.

One embodiment may also be implemented in the form of a computer-readable recording medium including instructions executable by a computer, such as a program module executable by the computer. The computer-readable recording medium may be any available medium that may be accessed by a computer and includes both volatile and nonvolatile media, and removable and non-removable media. In addition, the computer-readable recording medium may include both a computer storage medium and a communication medium. The computer storage medium includes all of volatile and nonvolatile media, and removable and non-removable media implemented by any method or technology for storage of information such as computer-readable instructions, data structures, program modules, or other data. The communication medium typically includes computer-readable instructions, data structures, other data in modulated data signals such as program modules, or other transmission mechanisms, and includes any information transfer media.

The descriptions of the above-described embodiments are merely examples, and it will be understood by one of ordinary skill in the art that various changes and equivalents thereof may be made. Therefore, the scope of the disclosure should be defined by the appended claims, and all differences within the scope equivalent to those described in the claims will be construed as being included in the scope of protection defined by the claims.

1. An aerosol generating device comprising:
a heater configured to heat an aerosol generating article;
a gas sensor configured to sense a concentration of a particular gas; and
a controller configured to control a supply of power to the heater, wherein the controller is configured to determine any one temperature profile from among a plurality of temperature profiles based on a sensing value of the gas sensor.

2. The aerosol generating device of claim 1, wherein the controller is configured to: accumulate, for a first period, the concentration of the particular gas sensed by the gas sensor; and determine any one temperature profile from among the plurality of temperature profiles, based on a value of the accumulated concentration of the particular gas.

3. The aerosol generating device of claim 1, wherein the controller is configured to tune the determined temperature profile based on a sensing value of the gas sensor.

4. The aerosol generating device of claim 3, wherein the controller is configured to: accumulate, for a first period, the concentration of the particular gas sensed by the gas sensor; and tune the determined temperature profile based on a difference value between a value of the accumulated concentration of the particular gas and a preset cumulative gas concentration expected value.

5. The aerosol generating device of claim 4, wherein the controller is configured to adjust a target temperature in a second period after the first period to be lower than a preset target temperature in proportion to the difference value when the difference value is a positive number.

6. The aerosol generating device of claim 4, wherein the controller is configured to adjust a second period after the first period to be shorter than a preset period when the difference value is a positive number.

7. The aerosol generating device of claim 4, wherein the controller is configured to adjust a target temperature in a second period after the first period to be higher than a preset target temperature in proportion to the difference value when the difference value is a negative number.

8. The aerosol generating device of claim 4, wherein the controller is configured to adjust a second period after the first period to be longer than a preset period when the difference value is a negative number.

9. The aerosol generating device of claim 1, wherein the gas sensor includes:
a light emitting device configured to emit light;
a light receiving device configured to receive the light; and
an optical waveguide located between the light emitting device and the light receiving device, and configured to allow the light to travel therethrough and allow the particular gas to be injected thereinto.

10. The aerosol generating device of claim 9, wherein the heater includes:
a coil configured to generate an alternating magnetic field; and
a susceptor configured to heat an aerosol generating article inserted into an accommodation space, by generating heat by the alternating magnetic field generated by the coil, wherein the susceptor is configured to form one surface of the optical waveguide.

11. A method of controlling an operation of an aerosol generating device, the method comprising:
initiating a heating operation of a heater configured to heat an aerosol generating article;
sensing a concentration of a particular gas of the aerosol generating device; and
determining any one temperature profile from among a plurality of temperature profiles based on a sensing value.

12. The method of claim 11, further comprising accumulating the concentration of the particular gas for a first period, and tuning the determined temperature profile based on a difference value between a value of the accumulated concentration of the particular gas and a preset cumulative gas concentration expected value.

13. The method of claim 12, wherein a target temperature in a second period after the first period is adjusted to be lower than a preset target temperature in proportion to the difference value when the difference value is a positive number.

14. The method of claim 12, wherein a second period after the first period is adjusted to be shorter than a preset period when the difference value is a positive number.

15. The method of claim 12, wherein a target temperature in a second period after the first period is adjusted to be higher than a preset target temperature in proportion to the difference value when the difference value is a negative number.
